(19) United States
(12) Patent Application Publication
(10) Pub. No.: US 2015/0078294 A1
(43) Pub. Date: Mar. 19, 2015

(54) SCHEDULING REQUEST IN WIRELESS COMMUNICATION SYSTEM

(71) Applicant: QUALCOMM Incorporated, San Diego, CA (US)

(72) Inventors: Ming YANG, San Diego, CA (US); Tom CHIN, San Diego, CA (US); Qinxin CHEN, Del Mar, CA (US); Guangming SHI, San Diego, CA (US)

(21) Appl. No.: 14/484,002

(22) Filed: Sep. 11, 2014

Related U.S. Application Data
(60) Provisional application No. 61/877,509, filed on Sep. 13, 2013.

(51) Int. Cl. H04W 72/04

(52) U.S. Cl. CPC H04W 72/048
USPC 370/329

(57) ABSTRACT

A method of wireless communication includes transmitting an abbreviated scheduling request indicating a general size of a first grant when a UE has buffered data. A detailed schedule request is transmitted and indicates a specific size of a second grant after receiving the first grant. The second grant is adjusted based on the detailed scheduling request.

### CROSS REFERENCE TO RELATED APPLICATIONS

The present application claims the benefit of U.S. Provisional Patent Application No. 61/877,509, filed on Sep. 13, 2013, in the names of Ming YANG et al., the disclosure of which is expressly incorporated by reference herein in its entirety.

### TECHNICAL FIELD

Aspects of the present disclosure relate generally to wireless communication systems, and more particularly, to an improved scheduling request.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes transmitting an abbreviated scheduling request indicating a general size of a first grant when a UE has buffered data. The method also includes transmitting a detailed scheduling request indicating a specific size of a second grant after receiving the first grant, the second grant being adjusted based on the detailed scheduling request.

Another aspect discloses wireless communication having a memory and at least one processor coupled to the memory. The processor(s) is configured to transmit an abbreviated scheduling request indicating a general size of a first grant when a UE has buffered data. The processor(s) is also configured to transmit a detailed scheduling request indicating a specific size of a second grant after receiving the first grant, the second grant being adjusted based on the detailed scheduling request.

Another aspect discloses a computer program product for wireless communications in a wireless network having a non-transitory computer-readable medium. The computer readable medium has non-transitory program code recorded thereon which, when executed by the processor(s), causes the processor(s) to perform operations of transmitting an abbreviated scheduling request indicating a general size of a first grant when a UE has buffered data. The program code also causes the processor(s) to transmit a detailed scheduling request indicating a specific size of a second grant after receiving the first grant, the second grant being adjusted based on the detailed scheduling request.

Another aspect discloses an apparatus including means for transmitting an abbreviated scheduling request indicating a general size of a first grant when a UE has buffered data. The apparatus also includes means for transmitting a detailed scheduling request indicating a specific size of a second grant after receiving the first grant, the second grant being adjusted based on the detailed scheduling request.

In one aspect, a method of wireless communication is disclosed. The method includes receiving an abbreviated scheduling request indicating a general size of a requested first grant when a UE has buffered data. The first grant is transmitted based on the abbreviated scheduling request. A detailed scheduling request indicating a specific size related to a UE buffer is received. Additionally, the second grant is transmitted based on the detailed scheduling request, the second grant being adjusted from the first grant.

Another aspect discloses wireless communication having a memory and at least one processor coupled to the memory. The processor(s) is configured to receive an abbreviated scheduling request indicating a general size of a requested first grant when a UE has buffered data. The processor(s) is also configured to transmit the first grant based on the abbreviated scheduling request. The processor(s) is also configured to receive a detailed scheduling request indicating a specific size related to the UE buffer. Further, the processor(s) is also configured to transmit the second grant based on the detailed scheduling request, the second grant being adjusted from the first grant.

Another aspect discloses a computer program product for wireless communications in a wireless network having a non-transitory computer-readable medium. The computer readable medium has non-transitory program code recorded thereon which, when executed by the processor(s), causes the processor(s) to perform the operation of receiving an abbreviated scheduling request indicating a general size of a requested first grant when a UE has buffered data. The program code also causes the processor(s) to transmit the first grant based on the abbreviated scheduling request. The program code also causes the processor (s) to receive a detailed scheduling request indicating a specific size related to a UE buffer. Further, the program code also causes the processor(s) to transmit the second grant based on the detailed scheduling request, the second grant being adjusted from the first grant.

Another aspect discloses an apparatus including means for receiving an abbreviated scheduling request indicating a general size of a requested first grant when a UE has buffered data. The apparatus also includes means for transmitting the first grant based on the abbreviated scheduling request. Additionally, the apparatus also includes means for receiving a detailed scheduling request indicating a specific size related to a UE buffer. Further, the apparatus includes means for transmitting the second grant based on the detailed scheduling request, the second grant being adjusted from the first grant.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a timing diagram illustrating a conventional scheduling request process.

FIG. 5 is a timing diagram illustrating a scheduling request process according to aspects of the present disclosure.

FIG. 6 is a flow diagram illustrating a wireless communication method for transmitting scheduling requests according to aspects of the present disclosure.

FIG. 7 is a flow diagram illustrating a wireless communication method for receiving scheduling requests according to aspects of the present disclosure.

FIG. 8 is a block diagram illustrating an example of a hardware implementation for an apparatus employing a processing system.

FIG. 9 is a block diagram illustrating another example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

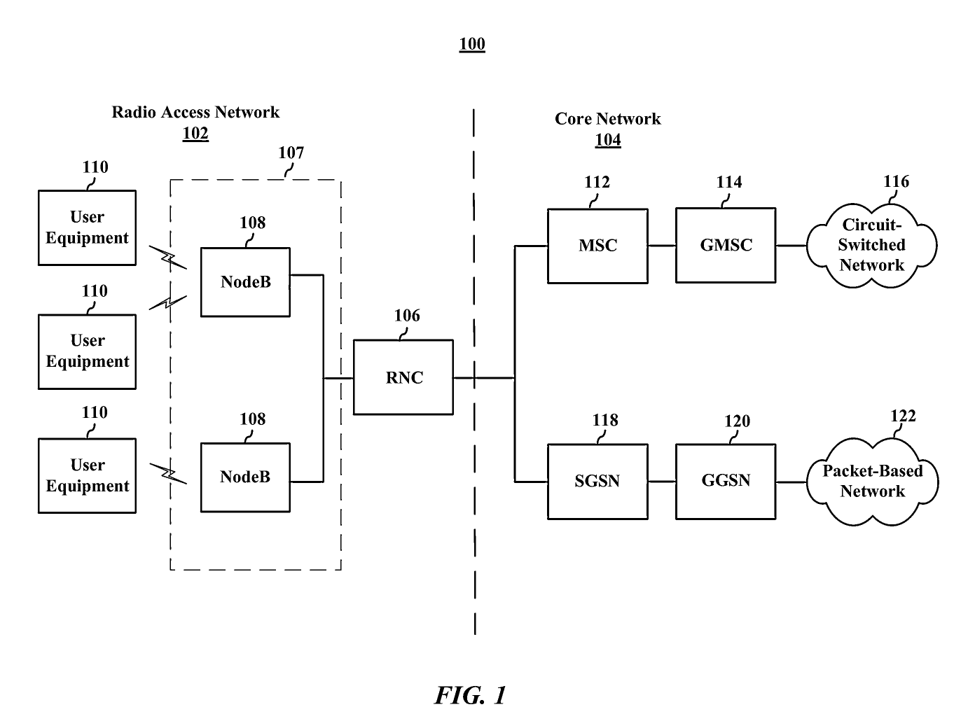

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving general packet radio service (GPRS) support node (SGSN) 118 and a gateway GPRS support node (GGSN) 120. GPRS, which stands for General Packet Radio Service, is designed to provide packet-data services at speeds higher than speeds available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

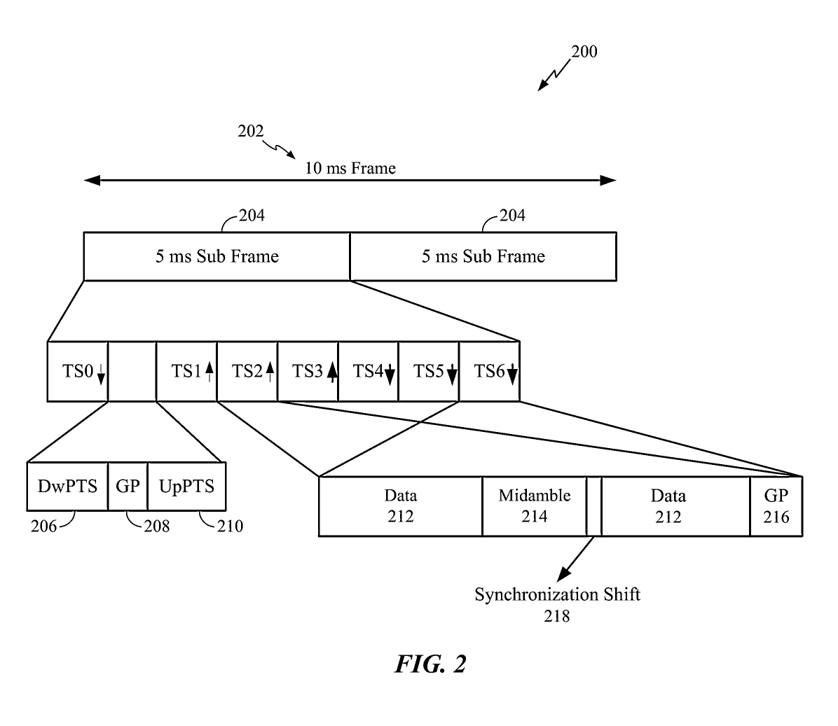

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

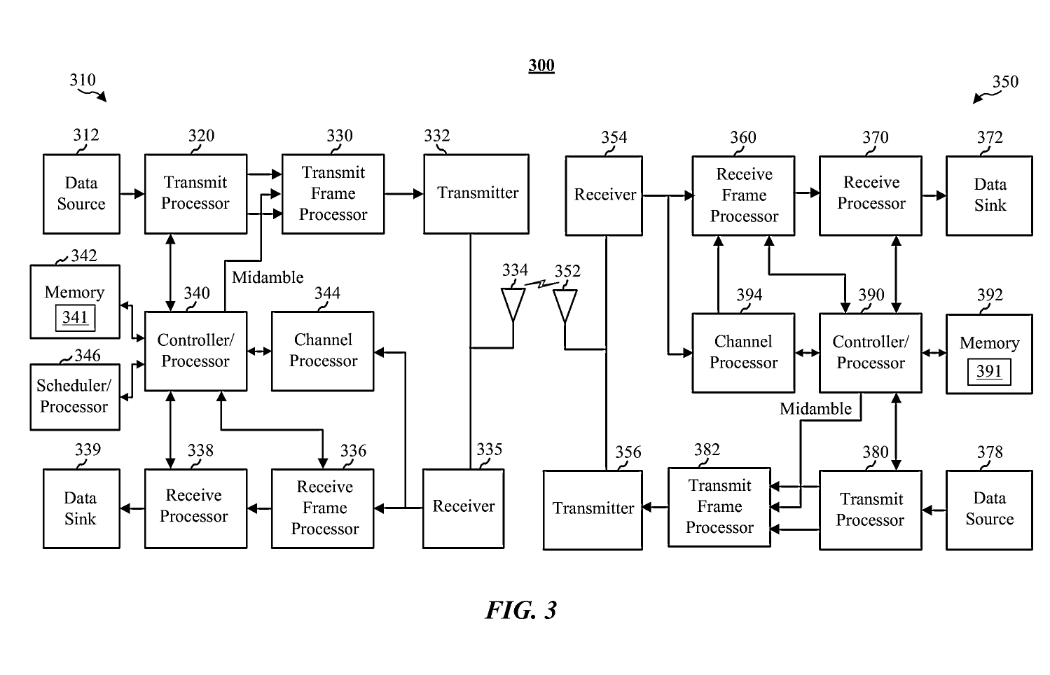

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for the unsuccessfully decoded frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for the unsuccessfully decoded frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a scheduling request transmitting module 391 which, when executed by the controller/processor 390, configures the UE 350 to transmit a scheduling request. In addition, the memory 342 of the node B 310 may store a scheduling request receiving module 341 which, when executed by the controller/processor 340, configures the node B 310 to receive a scheduling request. A scheduler/processor 346 at the node B 310 may be used to allocate resources to the UEs and schedule downlink and/or uplink transmissions for the UEs.

Time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in the E-PUCH channel can be transmitted in a burst fashion.

The E-DCH uplink control channel (E-UCCH) carries layer 1 (or physical layer) information for E-DCH transmissions. The transport block size may be six bits and the retransmission sequence number (RSN) may be two bits. Also, the hybrid automatic repeat request (HARQ) process ID may be two bits.

The E-DCH random access uplink control channel (E-RUCCH) is an uplink physical control channel that carries SI and enhanced radio network temporary identities (E-RNTI) for identifying UEs.

The absolute grant channel for E-DCH or enhanced access grant channel (E-AGCH) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NACK signals.

The operation of TD-HSUPA may also have the following steps.

Resource request: the UE sends requests (e.g., in scheduling information (SI)) via the E-PUCH or the E-RUCCH to a base station (e.g., NodeB). The requests may include permission to transmit on the uplink channels.

Resource allocation: the base station, which controls the uplink radio resources, allocates resources. Resources are allocated in terms of scheduling grants (SGs) to individual UEs based on their requests.

UE transmission: the UE transmits on the uplink channels after receiving grants from the base station. The UE determines the transmission rate and the corresponding transport format combination (TFC) based on the received grants. The UE may also request additional grants if it has more data to transmit.

Base station reception: a hybrid automatic repeat request (hybrid ARQ or HARQ) process is employed for the rapid retransmission of erroneously received data packets between the UE and the base station.

The transmission of scheduling information (SI) may consist of two types in TD-HSUPA: (1) in-band and (2) out-band. For in-band, which may be included in a medium access control e-type protocol data unit (MAC-e PDU) on the E-PUCH, data can be sent standalone or may piggyback on a data packet. For out-band, scheduling information may be sent on the E-RUCCH in case the UE does not have a grant, or the grant expires.

Scheduling information (SI) includes the following information or fields.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC). The TEBS field also indicates the amount of data, in number of bytes, that is available for transmission and retransmission in the radio link control (RLC) layer. When the medium access control (MAC) is connected to an acknowledged mode (AM) RLC entity, the TEBS includes control protocol data units (PDUs) to be transmitted and RLC PDUs outside the RLC transmission window. RLC PDUs that have been transmitted but not negatively acknowledged by the peer entity shall not be included in the TEBS. The actual value of TEBS transmitted is one of 31 values that are mapped to a range of bytes (e.g., 5 mapping to TEBS, where 24<TEBS <32).

The highest priority logical channel buffer status (HLBS) field indicates the amount of data available from the logical channel identified by HLID, relative to the highest value of the buffer size reported by TEBS. In one configuration, the buffer size report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power to the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

### Scheduling Request in Wireless Communication System

Aspects of the disclosure are directed to improving scheduling requests in a high speed uplink packet access (HSUPA) system, such as time division-high speed uplink packet access (TD-HSUPA).

Some radio access technologies (RATs), such as time division-synchronous code division multiple access (TD-SCDMA), specify a unified frame structure for both uplink transmissions and downlink transmissions. The unified frame structure specifies the joint transmission of the transmit power control (TPC) and the synchronization shift (SS) bits. In some systems, the synchronization shift bits may be used for timing adjustments. Still, base stations may be synchronized via a positioning system, such as GPS. Therefore, the timing adjustments transmitted via synchronization shift bits may be superfluous for a base station that is synchronized via the positioning system. Nonetheless, the synchronization shift bits are still transmitted via the uplink channel due to the standards requirements.

In some cases, an uplink and downlink dedicated physical channel (DPCH), such as an associated DPCH (A-DPCH), may transmit signaling messages on data calls for a high speed uplink packet access system, such as TD-HSUPA. The signaling messages may include radio resource control (RRC) and non-access stratum (NAS) signaling messages. An associated physical channel may be transmitted on every subframe if the associated physical channel is configured in a non-time division multiplexed (TDM) mode. Alternatively, the associated physical channel may be transmitted on every N sub-frames if the associated physical channel is configured in a time division multiplexed mode. In one configuration, N is a multiple of two, such as 2, 4, or 8.

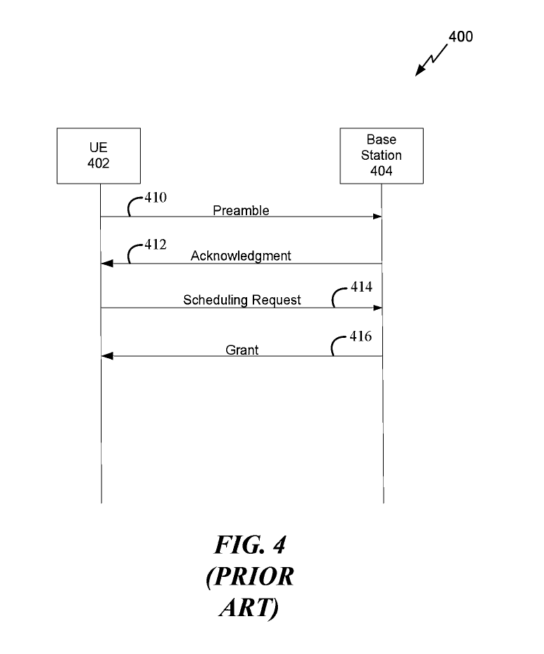

FIG. 4 is an example of a timing diagram 400 illustrating a conventional scheduling request process. In FIG. 4, the UE 402 is in a dedicated channel (DCH) state and a radio access bearer (RAB) connection, has been established with the base station 404. Furthermore, the UE 402 includes data that is buffered for transmission. However, the UE 402 has not received a grant to transmit the data or a previously received grant has expired. Thus, to request a grant for the buffered data, at time 410, a UE 402 transmits one of N synchronous uplink (SYNC-UL) preamble sequences to a base station 404. In one configuration, N is eight.

After transmitting the preamble sequence at time 410, the UE 402 waits to receive a response from the base station 404. The response may be transmitted via an access channel, such as the fast physical access channel (FPACH). If the UE 402 does not receive a response during a wait time (WT), the UE 402 transmits another uplink preamble sequence with an increased transmit power. The subsequent synchronous uplink preamble sequence may be the same or different form the synchronous uplink preamble sequence transmitted at time 410. In some cases, the number of subframes for the wait time is four.

Moreover, as shown in FIG. 4, at time 412, the base station 404 transmits an acknowledgment (ACK) signal in response to receiving the synchronous uplink preamble sequence. Furthermore, at time 412, the base station 404 may also transmit power and timing commands in response to receiving the synchronous uplink preamble sequence. The ACK, power command, and/or timing commands may be transmitted via an access channel, such as the fast physical access channel. Additionally, at time 414, in response to receiving the ACK, power command, and timing commands, the UE 402 transmits a scheduling request to the base station 404 via a random access channel, such as the enhanced data channel random access uplink control channel (E-RUCCH). The scheduling request may include a UE identification, such as an enhanced data channel radio network temporary identifier (E-RNTI). Finally, at time 416, the base station 404 transmits a grant to the UE 402. The grant may be transmitted via a grant channel, such as an enhanced access grant channel (E-AGCH).

In some cases, when a number of transactions and data channels is increased, conventional scheduling requests, such as the scheduling request transmission illustrated in FIG. 4, may experience reduced speeds and reduced efficiency. Moreover, as previously discussed, grants of some RATs, such as TD-HSUPA, may expire after a time period. As an example, if a grant duration expires during a data call and the UE includes data stored in a buffer, the UE transmits a preamble sequence to receive power and timing commands and then transmits a scheduling request via a random access uplink control channel. The scheduling request is transmitted to receive a grant to transmit the buffered data via an uplink channel, such as the enhanced physical uplink channel. Thus, due to the numerous transmissions that are specified to receive a grant, the transmission of a scheduling request transmitted via a random access uplink channel may degrade throughput and reduce performance.

According to an aspect of the present disclosure, a UE reduces a time for acquiring a resource grant by transmitting an abbreviated scheduling request via synchronization shift (SS) bits. That is, the abbreviated scheduling request is transmitted within the synchronization shift bits. The abbreviated scheduling request may be a fast scheduling request for enhanced uplink channel transmissions. In one configuration, the number of synchronization shift bits is two. In another configuration, the scheduling request is transmitted via a special burst. As previously discussed, timing adjustments transmitted via synchronization shift bits may be superfluous for some base stations. Therefore, aspects of the present disclosure are directed to transmitting an abbreviated scheduling request via the synchronization shift bits instead of transmitting a timing adjustment via the synchronization shift bits.

Furthermore, according to an aspect of the present disclosure, a detailed scheduling request is transmitted within padding bits of a data transmission for an uplink channel, such as a high speed data channel or an enhanced uplink channel. The padding bits may be padding bits for a media access control (MAC) electronic protocol data unit (e-PDU), an uplink high speed channel PDU, and/or a data payload. It should be noted that the channel established for the data transmission is established based on the grant received for the abbreviated scheduling request.

A grant includes both a resource grant and a power grant. In one configuration, a resource grant is determined based on an abbreviated scheduling request that is reduced in size or shortened in duration compared to a detailed scheduling request. Specifically, the UE transmits the abbreviated scheduling request to indicate a general size of a requested grant and receives a general sized grant based on the abbreviated scheduling request. Furthermore, the UE can transmit high speed uplink data to a base station after receiving the general sized grant. The power level can be a maximum allowed power level, in one aspect of the present disclosure. In another aspect, the power level is based on the timing advance. That is, the base station infers the distance to the UE based on the timing advance.

As previously discussed, a detailed scheduling request may be transmitted in the high speed uplink data. The detailed scheduling request indicates a specific size of a grant. Additionally, the detailed scheduling request may also include detailed scheduling information (SI) such as highest priority logical channel ID (HLID), total E-DCH buffer status (TEBS), highest priority logical channel buffer status (HLBS), UE power headroom (UPH) or generic power headroom, buffer size, and/or serving neighbor path loss (SNPL). In response to receiving the detailed scheduling request, the base station adjusts a size, a scheduling information resource, a parameter or a field of a general grant.

As previously discussed, the abbreviated scheduling request is indicated by a value of the synchronization shift bits. In one configuration, for the synchronization shift bits, a value of “00” indicates that a scheduling request or a grant is not desired, a value “01” indicates a small scheduling request or a small grant, the value “10” indicates a medium scheduling request or a medium size grant, and the value “11” indicates a large scheduling request or large grant. In this configuration, the small grant is one time slot and the medium grant is two or more time slots, and the large grant is a size that is greater than the medium grant. In another configuration, the size of a grants is based on a Walsh code implementation. Moreover, the grant size may also be based on the implementation of the base station.

After the base station receives an abbreviated scheduling request, the base station scheduler transmits a general grant, such as a small grant, a medium grant, or a large grant based on the received synchronization shift bits. A grant, such as the general grant and/or the detailed grant, may include a power grant and a resource grant. The resource grant may be determined based on the abbreviated scheduling request. Furthermore, the power grant may be determined based on the abbreviated scheduling request and/or a timing advance command.

The timing advance command may correspond to a distance between the UE and the base station. Additionally, the power grant may indicate a maximum allowed power level, such as the maximum allowed UE transmission power. The base station determines a power grant based on timing advance information or other information included in the abbreviated scheduling request. In one configuration, the base station determines the power grant based on the received power on an associated dedicated physical channel.

In one configuration, a detailed grant is 23 bits and includes information such as buffer size, power headroom, and/or serving neighbor path loss (SNPL). As previously discussed, the detailed scheduling request is transmitted in a data packet transmitted via an uplink channel, such as the enhanced physical uplink channel, after the UE receives a general grant via the grant channel. Moreover, the UE also receives a detailed grant based on information in the detailed scheduling request, such as the buffer size, power headroom, and/or serving neighbor path loss. That is, the base station scheduler adjusts the general grant based on the detailed scheduling request.

In some cases, the UE may experience an idle period when a scheduling request is not active. In one configuration, because transmissions are not scheduled during the idle periods, the UE tunes to other RATs to perform inter-RAT measurement.

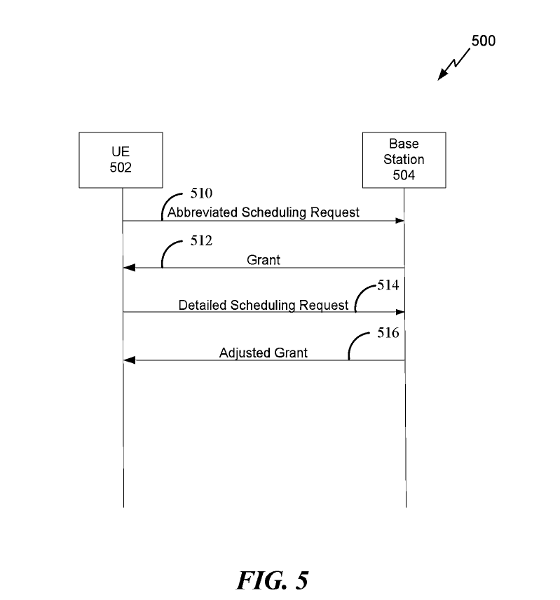

FIG. 5 is a timing diagram 500 illustrating a scheduling request process according to aspects of the present disclosure. In FIG. 5, the UE 502 is in a dedicated channel (DCH) state and a radio access bearer (RAB) connection, has been established with the base station 504. Furthermore, the UE 502 includes data that is buffered for transmission. However, the UE 502 has not received a grant to transmit the data or a previously received grant has expired. Therefore, the UE 502 transmits a scheduling request to receive a grant to transmit the buffered data. Specifically, at time 510, the UE 502 transmits an abbreviated scheduling request with synchronization shift bits via an uplink channel, such as an associated dedicated physical channel. Dedicated physical channels are configured to transmit synchronization shift bits. The synchronization shift bits indicate a general size of the scheduling request, such as small, medium, or large.

At time 512, the base station 504 transmits a general grant to the UE 502 based on the abbreviated scheduling request sent at time 510. The general grant may be transmitted via an enhanced access grant channel. Furthermore, at time 514, the UE 502 transmits a detailed scheduling request via an uplink channel established by the received general grant. The detailed scheduling request may be transmitted in padding bits, such as the padding bits of a data payload, or the padding bits of a media access control electronic protocol data unit (MAC ePDU). The detailed scheduling request also indicates a specific size of the requested grant. The detailed scheduling request may be transmitted from the UE 502 to the base station 504 via an enhanced physical uplink channel. In response to receiving the detailed scheduling request, the base station 504 adjusts the general grant and transmits the adjusted grant (e.g., detailed grant) to the UE 502 via a grant channel, such as an enhanced access grant channel.

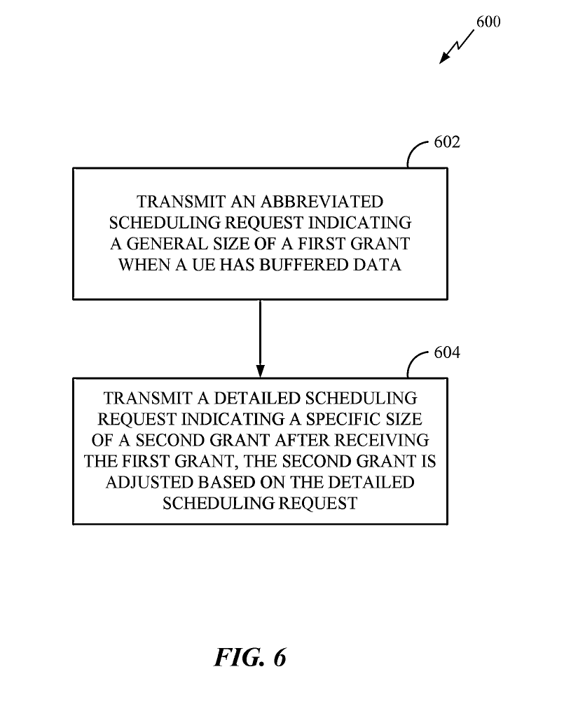

FIG. 6 is a flow diagram illustrating a wireless communication method 600 for transmitting scheduling requests according to aspects of the present disclosure. In block 602, a UE transmits an abbreviated scheduling request indicating a general size of a first grant when a UE has buffered data. In block 604, the UE transmits a detailed scheduling request indicating a specific size of a second grant after receiving the first grant. In one configuration, the second grant is adjusted based on the detailed scheduling request.

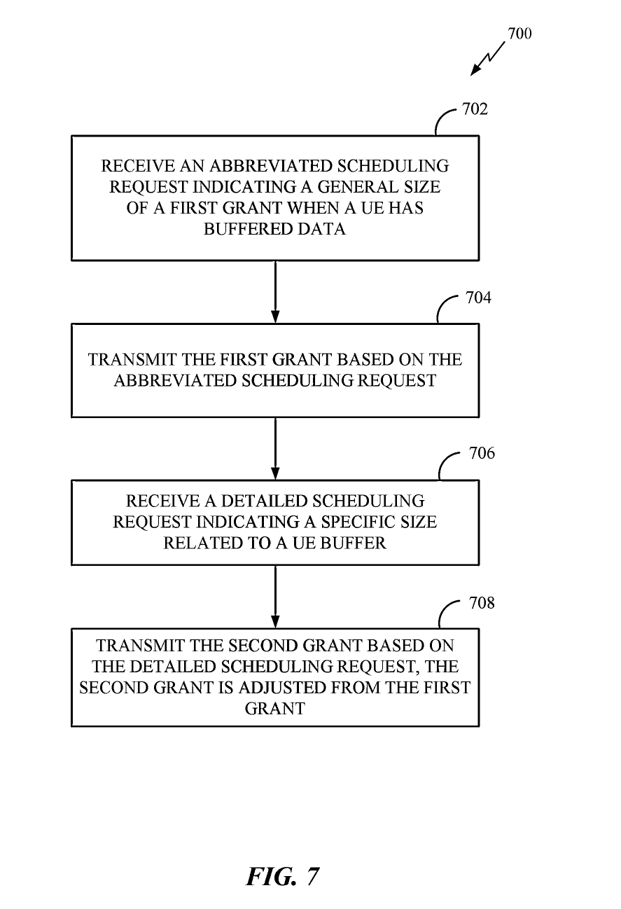

FIG. 7 is a flow diagram illustrating another wireless communication method 700 for receiving scheduling requests according to aspects of the present disclosure. In block 702, a base station receives an abbreviated scheduling request indicating a general size of a first grant when a UE has buffered data. In block 704, the base station transmits the first grant based on the abbreviated scheduling request. In block 706, the base station receives a detailed scheduling request indicating a specific size related to the a UE buffer. Furthermore, in block 708 the base station transmits the second grant based on the detailed scheduling request. In one configuration the second grant is adjusted from the first grant.

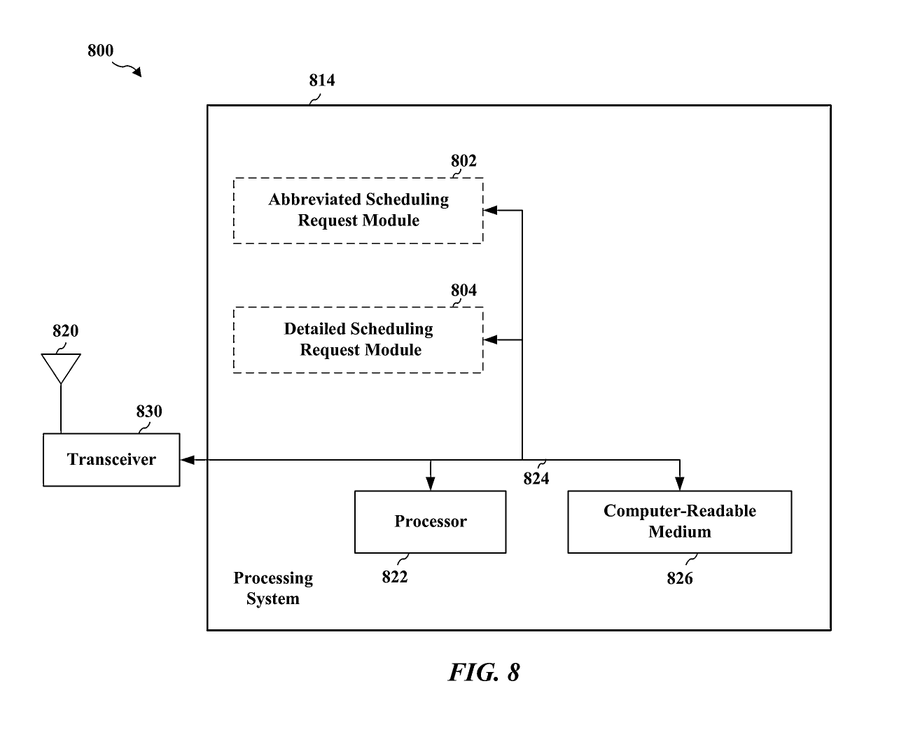

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the abbreviated scheduling request module 802, the detailed scheduling request 804 and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatuses over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes an abbreviated scheduling request module 802 for transmitting an abbreviated scheduling request indicating a general size of a first grant when a UE has buffered data. The processing system 814 also includes a detailed scheduling request module 804 for transmitting a detailed scheduling request indicating a specific size of a second grant after receiving the first grant. In another configuration, the abbreviated scheduling request module 802 and the detailed scheduling request module 804 may be housed in one module (not shown) rather than two separate modules. Although FIG. 8 illustrates one transmit module 802 for transmitting the abbreviated scheduling request and the detailed scheduling request, the processing system 814 is not limited to one transmit module and multiple transmit modules may be specified for the processing system 814. The modules may be software modules running in the processor 822, resident/stored in the computer-readable medium 826, one or more hardware modules coupled to the processor 822, or some combination thereof. The processing system 814 may be a component of the UE 350 and may include the memory 392, and/or the controller/processor 390.

In one configuration, an apparatus such as an UE 350 is configured for wireless communication including means for transmitting an abbreviated scheduling request. In one aspect, the above means may be the antennas 352, the transmitter 356, the transmit processor 380, the controller/processor 390, the memory 392, the scheduling request transmitting module 391, the abbreviated scheduling module 802, the processor 822, and/or the processing system 814 configured to perform the functions recited by the aforementioned means. In another aspect, the aforementioned means may be any module or any apparatus configured to perform the functions recited by the aforementioned means.

In one configuration, the apparatus configured for wireless communication also includes means for transmitting a detailed scheduling request. In one aspect, the above means may be the antennas 352, the transmitter 356, the transmit processor 380, the controller/processor 390, the memory 392, the scheduling request transmitting module 391, the detailed scheduling module 804, the processor 822, and/or the processing system 814 configured to perform the functions recited by the aforementioned means. In another aspect, the aforementioned means may be any module or any apparatus configured to perform the functions recited by the aforementioned means.

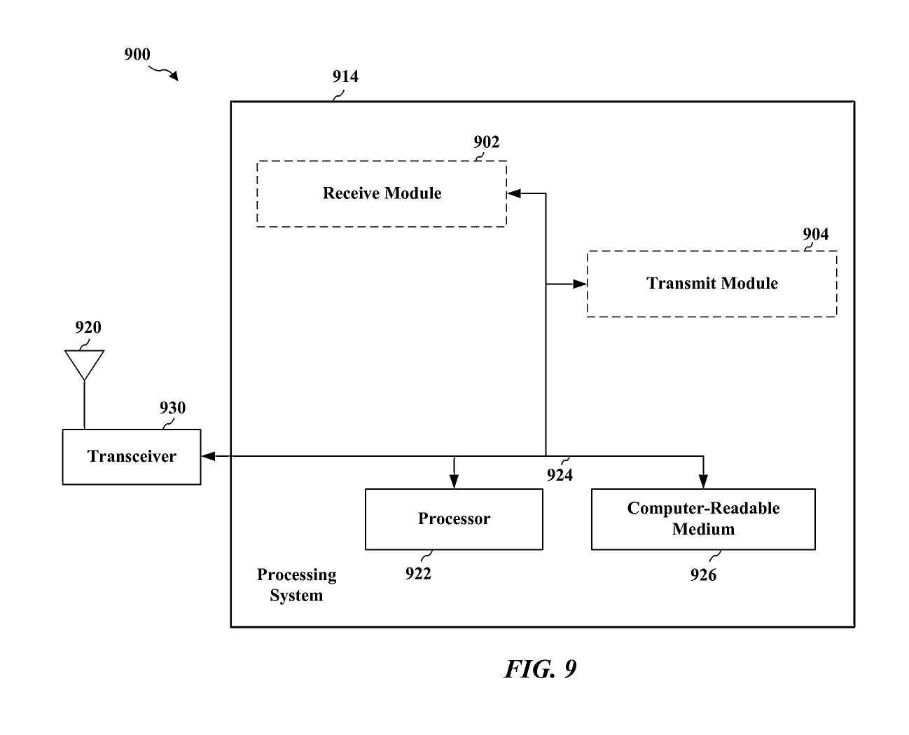

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922, the receive module 902, the transmit module 904, and the computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatuses over a transmission medium. The processing system 914 includes a processor 922 coupled to a computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a receive module 902 for receiving an abbreviated scheduling request indicating a general size of a first grant when a UE has buffered data. The receive module 902 may also be configured to receive a detailed scheduling request indicating a specific size of a second grant. The processing system 914 also includes a transmit module 904 for transmitting the first grant based on the abbreviated scheduling request. The transmit module 904 may also be configured to transmit the second grant based on the detailed scheduling request, the second grant being adjusted from the first grant. Although FIG. 9 illustrates one transmit module 802 for transmitting the first grant and the second grant, the processing system 914 is not limited to one transmit module and multiple transmit modules may be specified for the processing system 914. Likewise, multiple receive modules may also be specified for the processing system 914. The modules may be software modules running in the processor 922, resident/stored in the computer-readable medium 926, one or more hardware modules coupled to the processor 922, or some combination thereof. The processing system 914 may be a component of the node B 310 and may include the memory 342, and/or the controller/processor 340.

In one configuration, an apparatus such as a node B 310 is configured for wireless communication including means for receiving. In one aspect, the above means may be the antennas 334, the receiver 335, the receive processor 338, the controller/processor 340, the memory 342, the scheduling request receiving module 341, the receive module 902, the processor 922, and/or the processing system 914 configured to perform the functions recited by the aforementioned means. In another aspect, the aforementioned means may be any module or any apparatus configured to perform the functions recited by the aforementioned means.

In one configuration, the apparatus configured for wireless communication also includes means for transmitting. In one aspect, the above means may be the antennas 334, the transmitter 332, the transmit processor 320, the receiver 335, the receive processor 338, the controller/processor 340, the memory 342, the scheduling request receiving module 341, the transmit module 904, the processor 922, and/or the processing system 914 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems and/or TD-HSUPA. As those skilled in the art will readily appreciate, various aspects described throughout this disclosure may be extended to other telecommunication systems, network architectures and communication standards. By way of example, various aspects may be extended to GSM, as well as UMTS systems such as W-CDMA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this present disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
transmitting an abbreviated scheduling request indicating a general size of a first grant when a UE has buffered data; and
transmitting a detailed scheduling request indicating a specific size of a second grant after receiving the first grant, the second grant being adjusted based on the detailed scheduling request.

2. The method of claim 1, further comprising receiving the second grant based at least in part on the detailed scheduling request.

3. The method of claim 1, in which the detailed scheduling request is transmitted in padding bits of a data payload.

4. The method of claim 1, in which the abbreviated scheduling request indicates no grant, small grant, medium grant, or large grant request.

5. The method of claim 1, in which the abbreviated scheduling request is transmitted in at least synchronization shift (SS) bits of an uplink dedicated physical channel (DPCH), a special burst, or a combination thereof.

6. A method of wireless communication, comprising:
receiving an abbreviated scheduling request indicating a general size of a requested first grant when a UE has buffered data;
transmitting the first grant based on the abbreviated scheduling request;
receiving a detailed scheduling request indicating a specific size related to a UE buffer; and
transmitting a second grant based on the detailed scheduling request, the second grant being adjusted from the first grant.

7. The method of claim 6, in which the detailed scheduling request is received in padding bits of a data payload.

8. The method of claim 6, in which the abbreviated scheduling request indicates no grant, small grant, medium grant, or large grant.

9. The method of claim 6, in which the abbreviated scheduling request is received in at least synchronization shift (SS) bits of an uplink dedicated physical channel (DPCH), a special burst, or a combination thereof.

10. An apparatus for wireless communication, comprising:
a memory; and
at least one processor coupled to the memory, the at least one processor being configured:
to transmit an abbreviated scheduling request indicating a general size of a first grant when a UE has buffered data; and
to transmit a detailed scheduling request indicating a specific size of a second grant after receiving the first grant, the second grant being adjusted based on the detailed scheduling request.

11. The apparatus of claim 10, in which the at least one processor is further configured to receive the second grant based at least in part on the detailed scheduling request.

12. The apparatus of claim 10, in which the at least one processor is configured to transmit the detailed scheduling request in padding bits of a data payload.

13. The apparatus of claim 10, in which the abbreviated scheduling request indicates no grant, small grant, medium grant, or large grant request.

14. The apparatus of claim 10, in which the at least one processor is configured to transmit the abbreviated scheduling request in at least synchronization shift (SS) bits of an uplink dedicated physical channel (DPCH), a special burst, or a combination thereof.

15. An apparatus for wireless communication, comprising:
a memory; and
at least one processor coupled to the memory, the at least one processor being configured:
to receive an abbreviated scheduling request indicating a general size of a requested first grant when a UE has buffered data;
to transmit the first grant based on the abbreviated scheduling request;
to receive a detailed scheduling request indicating a specific size related to a UE buffer; and
to transmit a second grant based on the detailed scheduling request, the second grant being adjusted from the first grant.

16. The apparatus of claim 15, in which the at least one processor is further configured to receive the detailed scheduling request in padding bits of a data payload.

17. The apparatus of claim 15, in which the abbreviated scheduling request indicates no grant, small grant, medium grant, or large grant.

18. The apparatus of claim 15, in which the at least one processor is further configured to receive the abbreviated scheduling request in at least synchronization shift (SS) bits of an uplink dedicated physical channel (DPCH), a special burst, or a combination thereof.
